(19) United States
(12) Patent Application Publication
(10) Pub. No.: US 2016/0247198 A1
(43) Pub. Date: Aug. 25, 2016

(54) Online Lead-Generating Interactive Communication and Sales Method

(71) Applicant: David Johnson, JR., Fayetteville, NC (US)

(72) Inventor: David Johnson, JR., Fayetteville, NC (US)

(21) Appl. No.: 14/627,495

(22) Filed: Feb. 20, 2015

(51) Int. Cl. G06Q 30/02

(52) U.S. Cl. CPC G06Q 30/0258; G06Q 30/0277

(57) ABSTRACT

A method for a company to interact with customers via the internet configured to expedite reliable lead generation, and encourage positive reviews is described. The method is configured to provide incentive for prospective customers to provide contact information, and to facilitate the customers' access to reviews directly following the submission of contact information. Each prospective customer is presented with a video detailing an honest account of why he or she should choose to conduct business with the company over other competitors. The contact information submission page is prominent and easily located by prospects. Upon the prospect's submission of his or her contact information, a second video is triggered to display to the prospect, encouraging them to read recent reviews of the company, which preferably reinforce and confirm the positive, honest claims of the company. Following a sale, the customer is reminded and encouraged to leave a review immediately.

### FIELD OF THE PRESENT INVENTION

The present invention relates generally to methods of virtually interacting with customers over the internet, and more specifically relates to an online, lead-generating method oriented by triggered, procedural activities that facilitate leads to yield closed sales, and provide a higher return-on-investment from online advertising spending.

### BACKGROUND OF THE PRESENT INVENTION

Though it may seem counter-intuitive, most, if not all, customers do not wish to be merely ‘thanked’ on a web page with text or an image after submitting their request and/or contact information to a business online. The concept of ‘refraining from thanking’ is either unknown or ignored by nearly all business's websites. This fact can be seen by navigating to nearly any online business, as the majority of online businesses are known to thank customers for visiting their site, and for providing contact information.

It seems to reason that, if a customer arrives at a given business' website, the customer is looking for assistance, help, guidance and peace of mind from a business that is offering a product they are seeking To a customer, being ‘thanked’ by the business is their exit queue, as they have essentially been told to wait until further contact from a sales representative. The customer usually leaves this website and continues shopping at other websites because the customer's request for assistance has yet to be addressed.

The traditional forms of online marketing, sales, and lead generation that are presently found within conventional company websites are commonly configured to display merchandise, inform customers to present stock available, and to provide a means of contact between the prospective client and the business. These websites all appear identical to most customers seeking interaction with these businesses online for their product or service. Some business websites are equipped with a chat feature, enabling representatives of the business to converse and interact directly with customers while they visit the business' website.

Unfortunately, most prospective customers do not wish to type in order to talk to an unidentified sales person, and are more comfortable browsing the online inventory and educating themselves about the company. Usually individuals are more interested in creating their own opinion of a company, rather than have it sold to them. If prompted to chat, most customers avoid the option, wishing to explore the website and investigate the business independently. Companies that strongly encourage prospects to use the chat feature with intermittent pop-ups may even drive potential customers away from their website.

Worse yet, many company websites, especially conventional automobile dealer's websites, make it incredibly difficult to contact the company, transmit an inquiry (such as about a product, in-stock quantity, good, or service), or provide contact information. Frequently, the link that triggers the page providing the option to contact the company is buried deep within the website, often requiring over 10 mouse-clicks to locate and use a simple conventional contact form.

Commonly, if the customer does not abandon the website prior to locating the contact form, the prospect will conventionally enter his or her contact information, usually a name and means of contact.

Google referred to this moment as “the zero moment of truth” or “ZMOT”. The ZMOT occurs when a customer is trying to decide which product they want, and who they want to purchase it from. For most customers this is as very emotional and physiological moment. It is normal for one's palms to get clammy, arm pits to perspire, and heartbeat to increase during the ZMOT, because the customer is emotionally anticipating making some kind of connection with the business that is offering the product or service he or she wants or needs.

After the ZMOT, if the customer opts to provide contact information to the business online, psychologically investing in the company, conventional business websites simply show the prospective customer a message stating “Thank You for the Contact Information. We will contact you soon.” The prospective customer (or lead) is then shown a list of products, or directed to the homepage of the website. Essentially, the prospective customer is told to wait and the business will contact them when they have time. This message is not what the customer is anticipating. As the ZMOT is a very narrow emotional and physiological moment for the customer, he or she is more apt to feel more comfortable if he or she can confirm that the choice he or she made in selecting this business is the best one. Being thanked for your request is not the connection the customer is craving. A ‘thank you,’ therefore, is the customer's exit queue. Once a customer leaves the business website and continues searching to other businesses, the narrow moment for this business is gone, and it is almost impossible for this business to recreate it. This mismanagement of the ZMOT is the main reason the national close rate for leads is so low. Unfortunately, the prospective customer is now free to leave the website, and to browse to the websites of competitors.

It can be observed that every online business, regardless of size, practices a similar, archaic and formulaic method of ascertaining contact information of prospective customers within their own website online, complete with thanking the customer for their information, and often instructing them to wait patiently for further contact. This leads to less than stellar sales retention based on website advertising spending, as leads are less likely to convert to sales when prospects are nearly encouraged to leave the website of the business, often being forced to wait, prematurely thanked for their information, and convoluting the entire process by making the option of contact difficult to find. Ideally, a company should try to get the customer to choose one's business over others, to convince customers earnestly that one's business is genuinely the best.

In reality, the process of converting on-line leads to a sale takes a big effort. A business spends a lot of money and man hours chasing leads by making phone calls, emails, and text trying to connect with the customer. It is common for a salesman to make over 2,000 phone calls, text messages, and emails a year in order to chase down the prospect that would convert to a sale. The national average for conversion using this standard method of lead generation and follow-up is about 6-8%.

Thus, there is a need for a new method of interacting online between prospective customers and a business that produces leads that yield higher conversion ratings, and ultimately providing a better R.O.I. from online advertising expenses. Such a method would encourage customers directly to elect their business over those of competitors, and provide direct, honest, and reinforced rational for this choice based on apparent, easy to locate reviews triggered by informational targeted videos displayed to the prospective customer upon arrival at the website of the business.

### SUMMARY OF THE PRESENT INVENTION

The present invention is a method and system for interacting with prospective customers online configured to consistently generate high-return leads for a business. The preferred embodiment of the present invention employs a series of triggered videos and events designed to encourage and motivate the prospective customer to elect the business rather than competitors' businesses. There are several primary elements that differentiate the present invention from conventional online business sales methods or lead generation methods. These differentiations are critical to the present invention's greater capacity to capture the ZMOT of more customers than traditional methods.

The essential progression of the method of the present invention is preferably outlined as follows:

First, a prospective customer requiring interaction with a business for a product or service navigates to the website of the business (often through a search engine), and brings up the home page of the business website. The customer's visit to the website triggers a welcome video to be displayed on the business website with a very specific message. The message is designed to vary according to the trade of the business. In essence, the welcome video begins to try to convince the prospective customer that this business is the correct business to choose, regardless of the trade. The welcome video employed by the present invention is configured to prompt the customer to input his or her contact information.

The ZMOT, as referenced earlier, refers to the moment in which the customer enters his or her contact information in the contact form commonly found on a contact submission form. The method of the present invention bypasses the conventional and useless ‘thank-you page’ commonly displayed after contact information is submitted. This interaction then triggers a second video containing specific instructions for the customer on what to do now, as well as what to expect from the business owner to address the customer's anticipation of “making the connection” with the business. Links are also displayed correlating to the business' online reviews, so that the prospective customer can immediately read what other customers, similar to themselves, said about their experience. The reviews are preferably hosted on a third party website, such a Yelp, (or Google.) The easily referenced reviews facilitate the business in making a connection with the customer, and acquiring the contact information of the prospective customer within the ZMOT.

When a prospective customer clicks on an independent link to one of the reviews, the review is opened, in its entirety, within a separate tab, or within an inlaid browser window configured with the API and formatting found on the website employing the present invention. This ensures that the tab containing the website of the business is not closed, and that the prospective customer may continue to read reviews and learn more about the company, confirming what was posited within the welcome video.

Additionally, upon the prospective customer's completion of the contact information form, the website initiates an automated email response to the prospective customer configured to assist in capturing the prospective customer's ZMOT effectively, encouraging the customer that their decision was correct and just. The automated email preferably contains the same information displayed in the second video, namely reviews of the business, as well as links to other reviews on a variety of third-party review sites, along with a detailed description clearly stating why choosing this business is the right choice. Each step of the process of the present invention is invested in assisting the business in order to make a physiological connection with the customer. The website is configured to alert a sales person at the business by text and email alerts after the automated email is sent to the prospective customer, instructing him or her to contact the prospective customer as soon as possible.

A subsequent email, which is similar, may be automatically sent upon further contact with the prospective customer, such as after a salesman contacts the prospective customer later, preferably within 15 minutes. The window to capture the prospective customer's ZMOT is unfortunately very narrow, and once it is gone, it is almost impossible to recreate. The process of the present invention expands the customer's ZMOT duration much longer, giving the target business better odds of capturing the customer's ZMOT. With a more drawn-out ZMOT, the average business lead close rate can easily increase 200-300%, a substantial difference in the realm of online and sales and business.

As such, the timely interaction between the business and the prospective customer facilitated by the present invention employing videos, reviews, and emails greatly enhances the customer's experience and satisfaction with the process. Therefore, more leads are likely to lead to tangible results with higher conversion rates than the national average for sales leads.

### BRIEF DESCRIPTION OF THE DRAWINGS

The present invention will be better understood with reference to the appended drawing sheets, wherein:

FIG. 1 displays a flow chart depicting the process overarching the method of the present invention.

FIG. 2 shows an example layout of the post-contact information submission screen.

FIG. 3 exhibits an example layout of the contact information submission screen.

### DETAILED DESCRIPTION OF THE PREFERRED EMBODIMENT

The present invention is a lead-generating and lead conversion method for sales that employs the internet to interact with prospects, informing them with triggered videos, convincing prospects of the advantages of a business so as to encourage them to choose the business over similar competitors. The method of the present invention consists of a strategic, semi-automated interaction that occurs between a website of the business and a prospective customer (prospect). The method of the present invention employs a welcome video (10), a contact submission form (20), a second video (30), reviews (40) of the business, links to reviews (50), and an automated email in order to entice the prospect to discover more about the company, inform them of what they will discover, help them discover it for themselves, and facilitate contact information submission by the prospect rapidly upon arrival to the website of the business. These elements are employed within the method of the present invention to facilitate higher lead conversion rates than the national average of 8% with proven results.

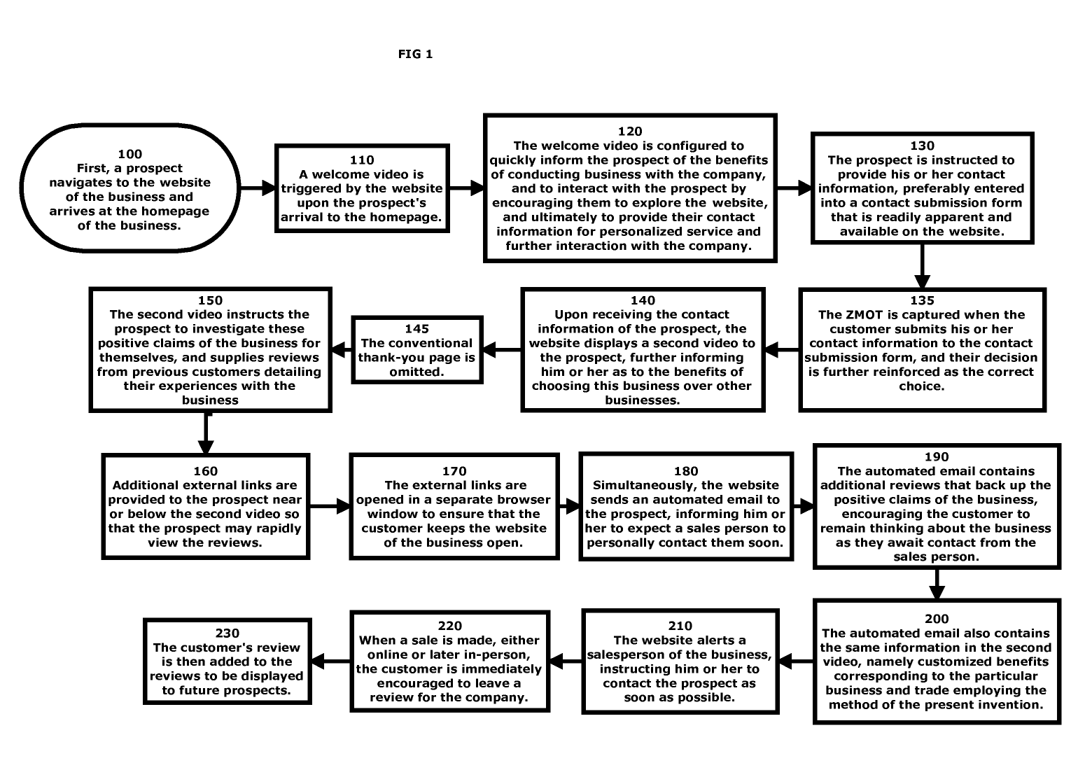

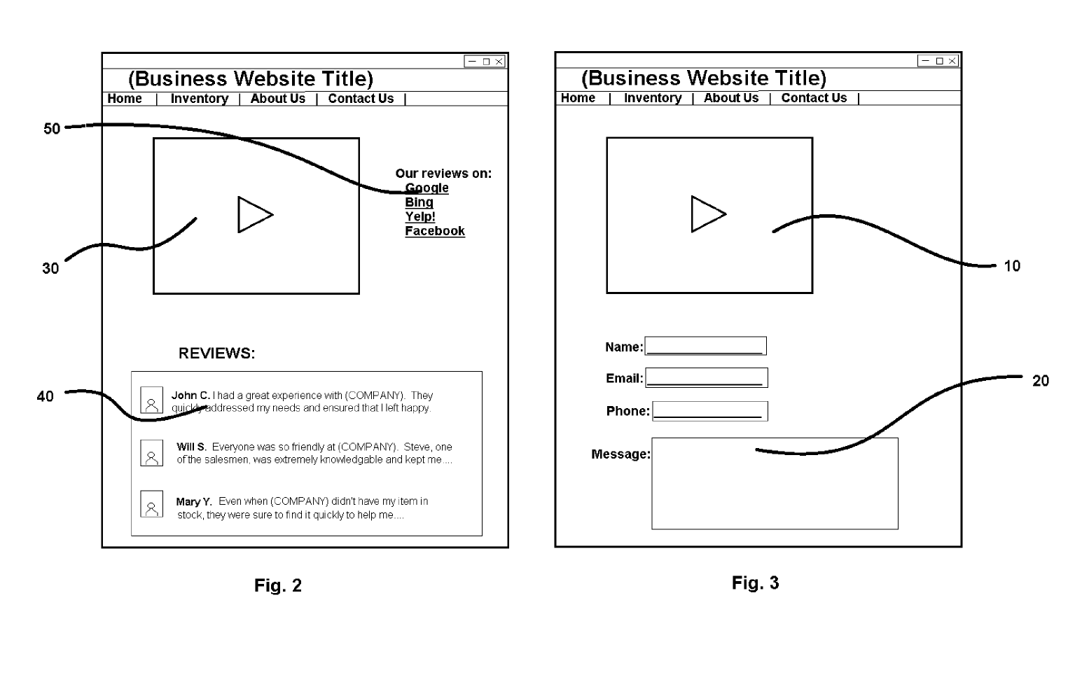

As seen in FIG. 1, the method of the present invention is preferably as follows:

First, a prospect navigates to the website of the business and arrives at the homepage of the business. (100) A welcome video (10) is triggered by the website upon the prospect's arrival to the homepage. (110) The welcome video (10) is configured to quickly inform the prospect of the benefits of conducting business with the company, and to interact with the prospect by encouraging them to explore the website, and ultimately to provide their contact information for personalized service and further interaction with the company. (120) The prospect is instructed to provide his or her contact information, preferably entered into a contact submission form (20) that is readily apparent and available on the website. (130) The ZMOT is captured when the customer submits his or her contact information to the contact submission form (20), and their decision is further reinforced as the correct choice. (135)

Upon receiving the contact information of the prospect, the website displays a second video to the prospect, further informing him or her as to the benefits of choosing this business over other businesses. (140) It should be noted that the conventional thank-you page is omitted when the method of the present invention is employed, as it has proven ineffective and seemingly without purpose. (145) The second video instructs the prospect to investigate these positive claims of the business for themselves, and supplies reviews (40) from previous customers detailing their experiences with the business (150). The second video (30) is displayed during the moment when the customer is craving or requesting contact with the target business. This interaction by the website videos and email template's is very reassuring to the customer so he\she anticipates making the “connection” to the target business. Additional external links are provided to the prospect near or below the second video so that the prospect may rapidly view the reviews. (160) The website is configured to open the external links in a separate browser window to ensure that the customer keeps the website of the business open. (170)

Simultaneously, the website sends an automated email to the prospect, informing him or her to expect a sales person to personally contact them soon. (180). The automated email contains additional reviews that back up the positive claims of the business, encouraging the customer to remain thinking about the business as they await contact from the sales person. (190) The automated email also contains the same information in the second video (30), namely customized benefits corresponding to the particular business and trade employing the method of the present invention. (200) The reviews are geared to educate the prospect, causing them to be more relaxed after knowing the nature of the company they are dealing with, what to do, and what to expect. Additionally, the reviews ensure that the customer is anticipating making the connection with the business, helping the business generate higher close rates and capture more of their customer's ZMOTs.

After the automated email is sent via the website of the business, the website alerts a salesperson of the business, instructing him or her to contact the prospect as soon as possible. (210) If the sales person is able to quickly respond to the prospect, the likelihood of converting a sale increases. When a sale is made, either online or later in-person, the customer (previously the prospect) is immediately encouraged to leave a review for the company. (220) Given that happy customers are less likely to review a company than disgruntled customers, it is crucial to tell customers to review the company immediately. The customer's review is then added to the reviews to be displayed to future prospects. (230)

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method for generating reliable sales leads online for a company via an internet-connected device on a website comprising:
the internet-connected device displaying a first video to a prospective customer;
the first video instructing prospective customers to provide their contact information within adjacent text fields in a contact submission form;
the first video detailing earnest advantages of the company;
the website processing the entered contact information from the contact submission form;
the website displaying a second video to the prospective customer;
the second video instructing prospective customers to read reviews of the company from prior customers similar to themselves;
the website displaying selected, positive reviews of the company to the prospective customer within the website;
the website displaying external links to third-party review sites containing additional reviews about the company;
the website opening the external links in a separate tab when clicked;
wherein the external links are disposed adjacent to the second video;
the website sending an automated email to the prospective customer containing the additional reviews; and
the website alerting a sales person at the company about the prospective customer, instructing the sales person to contact the prospective customer as soon as possible.

2. The method of claim 1, wherein the additional reviews are HTML links to external third-party review sites.

3. The method of claim 1, wherein the reviews depict a positive experience with the company.

4. The method of claim 1, wherein the contact submission form is easily identifiable on the website.

5. The method of claim 1, wherein the contact submission form can be accessed on the website by the prospective customer with two clicks of the mouse.
